(19) United States
(12) Patent Application Publication
(10) Pub. No.: US 2009/0051845 A1
(43) Pub. Date: Feb. 26, 2009

(54) DISPLAY APPARATUS

(75) Inventor: Yuji TSUCHIYAMA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Tokyo (JP)

(21) Appl. No.: 12/174,968

(22) Filed: Jul. 17, 2008

(30) Foreign Application Priority Data
Aug. 23, 2007 (JP) 2007-216891

(51) Int. Cl. G02F 1/1333

(52) U.S. Cl. 349/58

(57) ABSTRACT

The display apparatus of the invention includes a liquid crystal display panel, a front frame installed in a front face side of the liquid crystal display panel and protecting a peripheral edge portion of the liquid crystal display panel, and a middle frame including a member which is adjacent to at least a side surface of the liquid crystal display panel in an inner side of the front frame. The member of the middle frame includes a projection portion which protrudes in a front face direction of the liquid crystal display panel, and has an elastic force pushing the front frame in a front face direction of the liquid crystal display panel.

### BACKGROUND OF THE INVENTION

1. Field of the Invention

The present invention relates to a display apparatus provided with a frame protecting a peripheral edge portion.

2. Description of the Background Art

Japanese Patent Application Laid-Open No. 5-165012 shows a structure surrounding and protecting a panel by a protecting frame (hereinafter, refer to as a frame) having a thickness more than a total thickness of a liquid crystal display panel, for preventing a chipping of a glass substrate constructing the liquid crystal display panel, and a scratch on a polarizing plate.

However, in the structure of the publication mentioned above, it is possible to prevent the chipping of the glass substrate and the scratch on the polarizing plate, however, since a side wall having the thickness more than the total thickness of the panel is necessary in the frame, there is a problem that the side wall gets in the way of thinning a whole of a liquid crystal module. Further, in the case that thinning is achieved by forming the side wall of the frame at the thickness nearly equal to the total thickness of the liquid crystal display panel, there is a problem that an end surface of the polarizing plate or the like closest to the surface of the panel interferes with the frame at a time of assembling, and a display quality is deteriorated by an effect of a deformation caused by a stress.

### SUMMARY OF THE INVENTION

An object of the present invention is to provide a display apparatus which prevents a frame from interfering with a display panel at a time of assembling and prevents a display quality from being deteriorated, while intending to make a whole of the display apparatus thin.

The display apparatus is provided with a display panel, a first frame, and a second frame.

The first frame is installed in a front face side of the display panel and protects a peripheral edge portion of the display panel.

The second frame is constructed by a member which is adjacent to at least a side surface of the display panel in an inner side of the first frame.

The member of the second frame is provided with a projection portion which protrudes in a front face direction of the display panel, and has an elastic force pushing the first frame in a front face direction of the display panel.

In a state in which the first frame is not fixed to the display panel, the projection portion is formed at a height which is higher than a position at which the display panel is arranged.

Since the first frame is brought into contact with the projection portion prior to the display panel at a time of assembling, thereby preventing a shock from being applied to the display panel, it is possible to protect the display panel. Further, since the first frame can employ such an assembling method as to be put from an upper side based on a provision of the projection portion, and the shock is not applied from the side face side in the display panel, it is possible to prevent a display quality from being lowered by a catch on an end surface of a polarizing plate. After assembling, since the projection portion has an elastic force, the projection portion becomes low to the same height as the display panel, and includes no unnecessary height portion, it is possible to make a thickness of the display apparatus minimum.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a top elevational view showing a liquid crystal display apparatus in accordance with the present invention;

FIG. 2 is a top elevational view showing the liquid crystal display apparatus before a front frame in accordance with the present invention is put on;

FIG. 3 is a cross sectional view showing the liquid crystal display apparatus before the front frame in accordance with the present invention is fixed;

FIG. 4 is a cross sectional view showing the liquid crystal display apparatus after the front frame in accordance with the present invention is fixed;

FIG. 5 is a cross sectional view at a time when a projection portion is provided in a rear frame in the other embodiment in accordance with the present invention; and

FIG. 6 is a cross sectional view at a time when a spring portion is provided in a front frame in the other embodiment in accordance with the present invention.

### DESCRIPTION OF THE PREFERRED EMBODIMENTS

A description will be given below of the present invention based on the accompanying drawings showing its embodiment.

### (Structure)

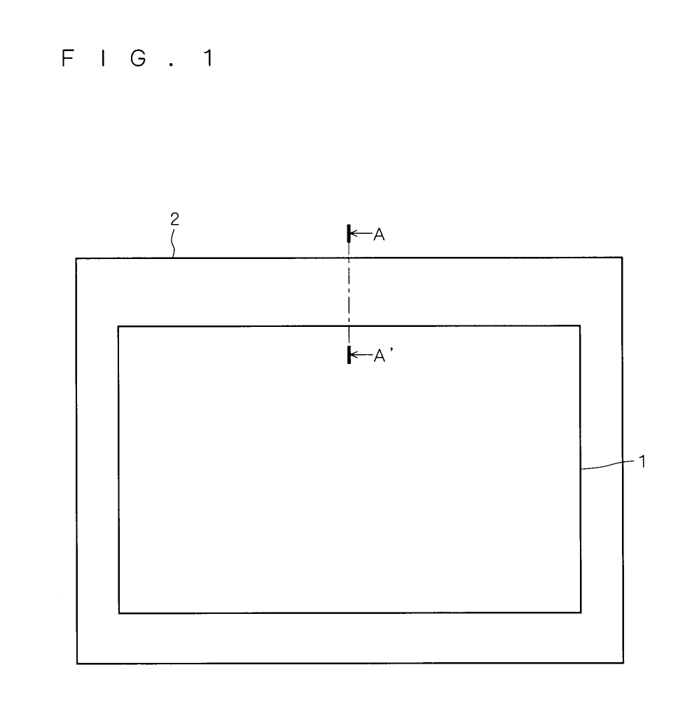

FIG. 1 is a view in which a liquid crystal display apparatus (a display apparatus) in the present embodiment is seen from a top surface. A liquid crystal display panel (a display panel) 1 is provided, and a front frame (a first frame) 2 protecting a peripheral edge portion is installed in a front surface side of the liquid crystal display panel 1.

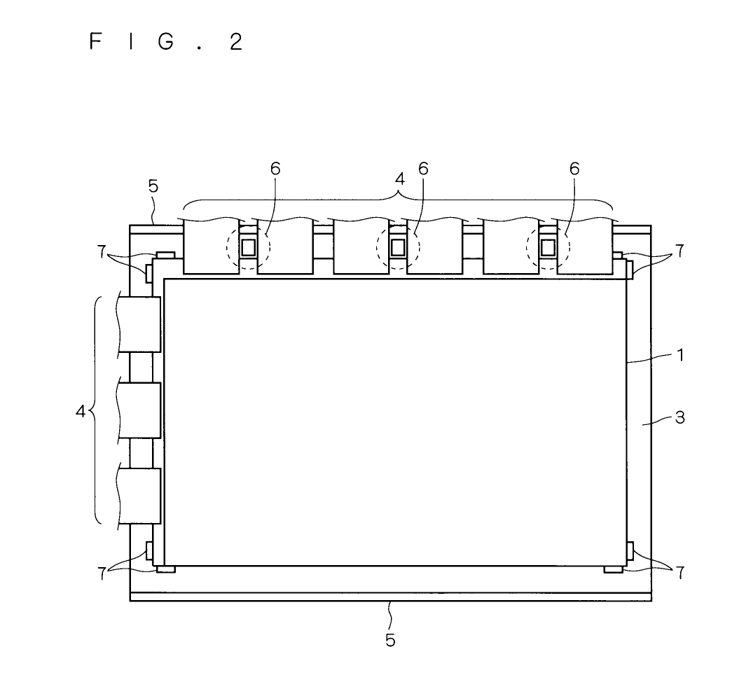

FIG. 2 is a view showing a state in which the front frame 2 is detached, in the liquid crystal display apparatus shown in FIG. 1.

The liquid crystal display apparatus is positioned in an inner side of the front frame 2, and is provided with a middle frame (a second frame) 3 constructing a member which is adjacent to at least a side surface of the liquid crystal display panel 1. The liquid crystal display panel 1 is arranged in an opening portion (not shown) provided in a top surface of the middle frame 3 in such a manner that four sides are brought into contact with a display panel positioning guide 7 formed in a corner portion of the middle frame 3. A tape carrier package 4 (hereinafter refer to as TCP) serving as a circuit board is provided in a top side and a left side of the liquid crystal display panel 1, and an image of the liquid crystal display panel 1 is driven and controlled based on a motion of the TCP 4.

A back light unit (not shown) for irradiating a light is installed in a lower portion of the middle frame 3, and a rear frame 5 is installed in a lower portion of the back light unit. The back light unit is pinched by the rear frame 5 and the middle frame 3. In this case, the middle frame 3 may be structured such as to include a frame which is one constructing member of the back light, and is arranged in a back surface of the liquid crystal display panel 1. The front frame 2 shown in FIG. 1 is engaged with the rear frame 5, whereby the liquid crystal display apparatus is constructed.

Further, a projection portion 6 protruding in a front face direction of the liquid crystal display panel 1 is provided in a member of the middle frame 3 which is adjacent to the side surface of the liquid crystal display panel 1 in which the TCP 4 is arranged. The projection portion 6 has a spring structure in which if a force is applied in a direction of the rear frame 5, an elastic force is applied in a direction of the front frame 2. In other words, the projection portion 6 has an elastic force pushing the front frame 2 in the front face direction of the liquid crystal display panel 1.

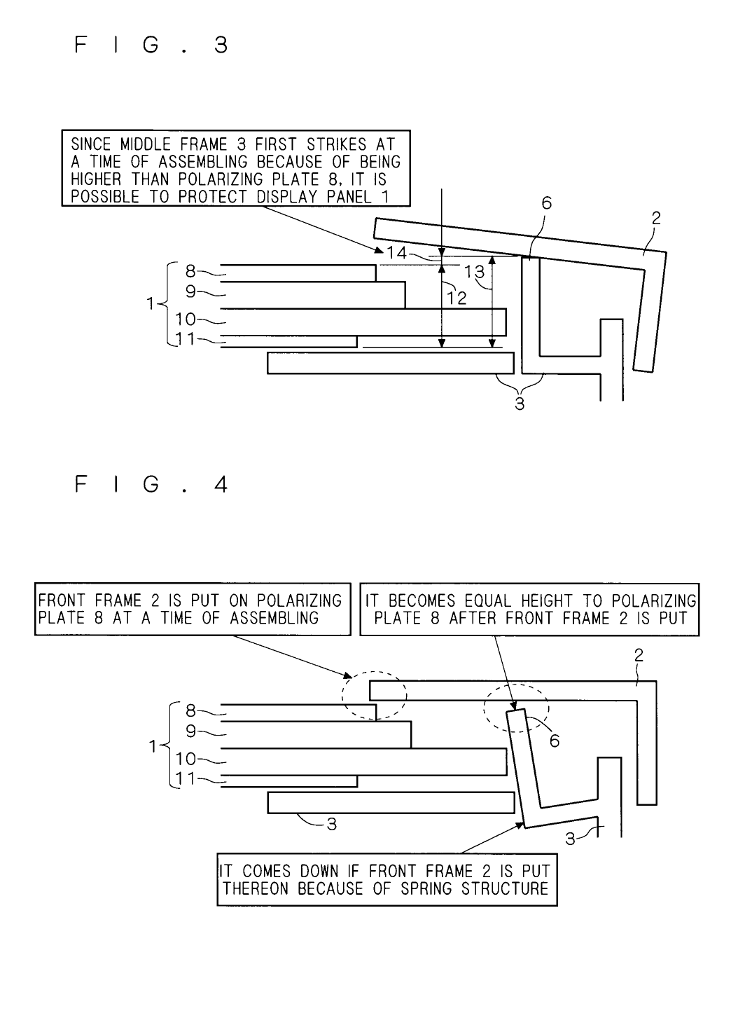

In this case, FIG. 3 is a cross sectional view before the front frame 2 in a line A-A′ shown in FIG. 1 is fixed to the liquid crystal display panel 1, and FIG. 4 is a cross sectional view after the front frame 2 is fixed.

The liquid crystal display panel 1 has a TFT glass substrate 10 in which the TFT or the like are formed, and a CF glass substrate 9 in which a color filter or the like are formed. Both the substrates are attached in an opposing manner by a seal material in a peripheral portion, and a liquid crystal is sealed between the opposing substrates. A TFT side polarizing plate 11 is formed on a surface of the TFT glass substrate 10, and a CF side polarizing plate 8 is formed on a surface of the CF glass substrate 9.

Further, as mentioned above, the liquid crystal display panel 1 is installed in an opening portion of the top surface of the middle frame 3, and the projection portion 6 protruding to the front frame 2 side is provided in a side portion of the middle frame 3.

As shown in FIG. 3, in a state in which the front frame 2 is not fixed to the liquid crystal display panel 1 at a time of assembling, a height 13 from the middle frame 3 of the projection portion 6 is formed so as to be higher than a height 12 in the case that the liquid crystal display panel 1 is arranged in the middle frame 3. In other words, the projection portion 6 is formed at a height which is more than a position at which the liquid crystal display panel 1 is arranged. Accordingly, in a state in which the front frame 2 is not fixed to the liquid crystal display panel 1, the front frame 2 does not come into contact with the liquid crystal display panel 1.

It is desirable that a dimension of a difference of elevation 14 between the projection portion 6 and the display panel 1 is equal to or more than a thickness of the CF side polarizing plate 8. In this case, the projection portion 6 may employ any shape as far as the projection portion 6 is provided with a spring structure in which the elastic force is applied in the direction of the front frame 2.

As shown in FIG. 4, in a state in which the front frame 2 after being assembled is fixed to the liquid crystal display panel 1, the projection portion 6 is fixed at an equal height to the liquid crystal display panel 1 by being pressed to the front frame 2. The front frame 2 is fixed in such a manner as to be put on the CF side polarizing plate 8.

### (Manufacturing Method)

Next, a description will be given of an assembling method of the liquid crystal display apparatus in accordance with the present invention, particularly an installation of the front frame 2, with reference to FIGS. 3 and 4.

As shown in FIG. 3, the liquid crystal display panel 1 is installed in the opening portion in the top surface of the middle frame 3. Next, the front frame 2 is put thereon while being inclined, however, the top side portion of the middle frame 3 provided with the projection portion 6 shown in FIG. 1 is first engaged with the front frame 2.

At this time, as shown in FIG. 3, the front frame 2 and the projection portion 6 of the middle frame 3 are brought into contact with each other, and the front frame 2 is finally engaged with the rear frame 5 while being rotated toward the rear frame 5 which is installed in the lower portion of the middle frame 3. Since the projection portion 6 of the middle frame 3 has the spring structure, the projection portion 6 is applied the elastic force in the direction of the front frame 2, at a time when the front frame 2 is engaged with the rear frame 5. Accordingly, in the state in which the front frame 2 is not fixed to the liquid crystal display panel 1, the front frame 2 does not come into contact with the liquid crystal display panel 1.

Thereafter, in the state in which the front frame 2 is fixed to the liquid crystal display panel 1, the projection portion 6 is fixed at the equal height to the liquid crystal display panel 1 by being pressed to the front frame 2, as mentioned above with regard to FIG. 4. The front frame 2 is fixed in such a manner as to be put on the CF side polarizing plate 8.

### (Effect)

In accordance with the present invention, since the front frame 2 is brought into contact with the projection portion 6 prior to the liquid crystal display panel 1 at a time of assembling, a shock is not applied to the liquid crystal display panel 1. Accordingly, it is possible to protect the liquid crystal display panel 1. Further, since the front frame 2 can employ such an assembling method as to be put thereon from the upper side, based on the provision of the projection portion 6, and the shock is not applied from the side surface side in the liquid crystal display panel 1, it is possible to prevent the display quality from being lowered by a catch on the end surface of the polarizing plate or the like. After assembling, since the projection portion 6 has an elastic force, the projection portion 6 becomes lower to the same height as the liquid crystal display panel 1, and no unnecessary height portion is provided. Accordingly, it is possible to make the liquid crystal display apparatus minimum in thickness.

In this case, the projection portion 6 is provided in the side portion of the middle frame 3 in which the TCP 4 is arranged, however, may be provided in the other sides as far as the structure which can achieve the effect of the present invention.

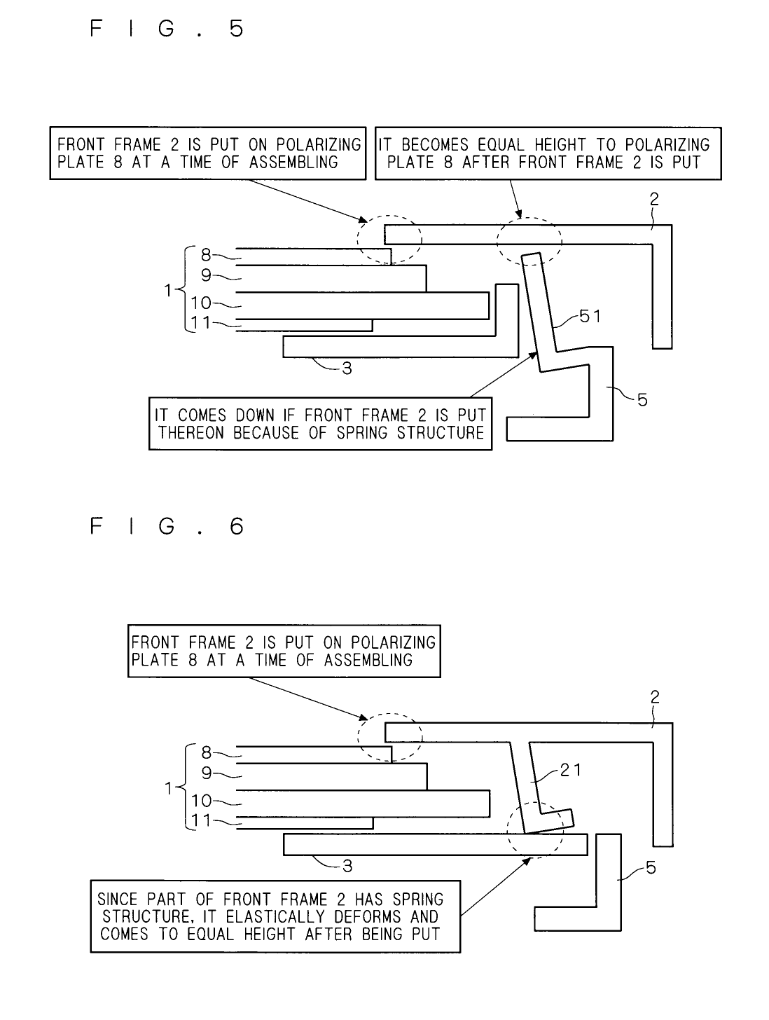

As the other embodiment in accordance with the present invention, a projection portion having a spring structure may be provided in the rear frame 5, as shown in FIG. 5. In a state in which a projection portion 51 having a spring structure is provided in the rear frame 5 installed in a lower portion of a back light unit (not shown), and the front frame 2 is fixed to the liquid crystal display panel 1, the projection portion 51 is brought into contact with the front frame 2 and is pressed thereto, thereby being fixed at an equal height to the liquid crystal display panel 1. Further, as shown in FIG. 6, a projection portion having a spring structure may be provided in the front frame. The liquid crystal display apparatus shown in FIG. 6 is provided with the front frame 2, and the middle frame 3 engaging with the front frame 2 so as to store the back light in an inner portion, and a projection portion 21 having an elastic force pushing the front frame 2 in a front face direction of the liquid crystal display panel 1 is provided in an opposing surface to the middle frame 3 in the front frame 2. In a state in which the front frame 2 is fixed to the liquid crystal display panel 1, the projection portion 21 is brought into contact with the middle frame 3 or the rear frame 5, and is pressed thereto, thereby being fixed at an equal height to the liquid crystal display panel 1.

While the invention has been shown and described in detail, the foregoing description is in all aspects illustrative and not restrictive. It is therefore understood that numerous modifications and variations can be devised without departing from the scope of the invention.

What is claimed is:

1. A display apparatus comprising:
a display panel;
a first frame installed in a front face side of said display panel and protecting a peripheral edge portion of said display panel; and
a second frame constructed at least by a member which is adjacent to a side surface of said display panel in an inner side of said first frame,
wherein said member of said second frame is provided with a projection portion protruding in a front face direction of said display panel, and having an elastic force pushing said first frame in a front face direction of said display panel, and
wherein said projection portion is formed to have height which is higher than a position at which said display panel is arranged, in a state in which said first frame is not fixed to said display panel.

2. The display apparatus as claimed in claim 1, further comprising:
a back light,
wherein said second frame includes a frame which is one constructing member of said back light and is arranged in a back face of said display panel.

3. The display apparatus as claimed in claim 1, wherein said projection portion is fixed at an equal height to said display panel by being pressed to said first frame, in a state in which said first frame is fixed to said display panel.
